(19) United States
(12) Patent Application Publication
(10) Pub. No.: US 2012/0135910 A1
(43) Pub. Date: May 31, 2012

(54) Aqueous Laundry Liquid Suitable for Packaging in Polyvinyl Alcohol Pouches

(75) Inventors: Stephen F. Gross, Souderton, PA (US); Anna Kvecher, Chalfont, PA (US); Josef Köster, Harleysville, PA (US); Michael Coxey, Norristown, PA (US)

(73) Assignee: Cognis IP Management GmbH, Dusseldorf (DE)

(21) Appl. No.: 13/272,724

(22) Filed: Oct. 13, 2011

Related U.S. Application Data
(60) Provisional application No. 61/393,550, filed on Oct. 15, 2010.

(51) Int. Cl. C11D 17/00

(52) U.S. Cl. 510/296; 510/337

(57) ABSTRACT

The present invention relates to a liquid cleaning composition comprising (i) at least one nonionic surfactant, (ii) at least one anionic surfactant, (iii) at least one non-aqueous solvent, and (iv) water, characterized in that the water content of the composition is below 10% by weight, and the composition is free of volatile organic compounds (VOCs). In addition, water-soluble packages such as pouches or sachets, containing the liquid cleaning composition, are provided.

### CROSS-REFERENCE TO RELATED APPLICATIONS

This application claims priority to U.S. provisional patent application Ser. No. 61/393,550, filed Oct. 15, 2010, which is incorporated herein by reference in its entirety.

### TECHNICAL FIELD

This invention pertains to the field of liquid detergent compositions, in particular liquid laundry compositions packaged in a water soluble container or packet.

### BACKGROUND

Unit packaging of laundry detergent in water-soluble sachets is a convenient way to provide detergents to consumers. Water-soluble packages are easy to use, and are safe for everyone involved in the transport and use of chemical compounds. The packaging products are suitable for a broad variety of ingredients and can be used in many kinds of applications, including the household sector. Unit packaging has been known for many years. U.S. Pat. No. 6,831,051 discloses cleaning compositions contained within a water-soluble pouch comprising two different compartments. U.S. Pat. No. 7,479,475 pertains to single compartment unit-dose products, containing a silicone fabric conditioner. Unit packaging of laundry detergent in water-soluble sachets has also been disclosed in U.S. Pat. No. 6,037,319; however, the compositions disclosed require substantial amounts of volatile solvents. For example, the laundry detergent disclosed in Example 4 contains about 74% dimethyl monoethyl ether.

It was an object of the present invention to provide detergent compositions for the use in water-soluble sachets, which do not contain such volatile organic compounds (VOCs).

### SUMMARY

The invention provides a liquid detergent for the use in unit-dose cleaning devices, like pouches, sachets and the like, whereby the detergent is free of VOCs.

### DETAILED DESCRIPTION

The present invention pertains to a liquid detergent composition comprising (i) at least one nonionic surfactant, (ii) at least one anionic surfactant, (iii) at least one non-aqueous solvent, and (iv) water, characterized in that the water content of the composition is below 10% by weight, and the composition is free of volatile organic compounds. The preferred embodiment is a liquid laundry detergent composition.

The term “volatile organic compounds” (VOCs) refers to organic chemical compounds which have significant vapor pressures and which can affect the environment and human health. VOCs are numerous, varied, and ubiquitous. Although VOCs include both man-made and naturally occurring chemical compounds, it is the anthropogenic VOCs that are regulated, especially for indoor applications where concentrations can be highest. VOCs are typically not acutely toxic but have chronic effects. The US Environmental Protection Agency (EPA) defines VOCs as follows: Volatile organic compounds (VOC) means any compound of carbon, excluding carbon monoxide, carbon dioxide, carbonic acid, metallic carbides or carbonates, and ammonium carbonate, which participates in atmospheric photochemical reactions, except those designated by EPA as having negligible photochemical reactivity.

The compositions of the present invention are free of any VOCs, in particular, they are free from lower alcohols and glycol ethers.

The liquid detergent compositions according to the present invention comprise at least one nonionic surfactant as component (i). Typical examples of nonionic surfactants are fatty alcohol polyglycol ethers, alkylphenol polyglycol ethers, fatty acid polyglycol esters, fatty acid amide polyglycol ethers, fatty amine polyglycol ethers, alkoxylated triglycerides, mixed ethers and/or mixed formals, optionally partially oxidized alk(en)yl oligoglycosides and/or gluconic acid derivatives, fatty acid N-alkylglucamides, protein hydrolysates (in particular wheat-based vegetable products), polyol fatty acid esters, sugar esters, sorbitan esters, polysorbates and amine oxides. If the nonionic surfactants contain polyglycol ether chains, these can have a conventional homologue distribution, but preferably have a narrow homologue distribution.

The nonionic surfactants are present preferably in amounts from 30 to 90 wt %, preferably 40 to 70%, based on the weight of the composition.

Within the context of the present invention, in particular alkyl (oligo) glycosides are suitable as component (i). Alkyl and alkenyl(oligo)glycosides are known nonionic surfactants which conform to formula (I)

R¹O[G]ₚ (I)

in which R¹ is an alkyl and/or alkenyl radical having 4 to 22 carbon atoms, G is a sugar radical having 5 or 6 carbon atoms, and p is a number from 1 to 10. They can be obtained by the relevant methods of preparative organic chemistry. The alkyl and/or alkenyl oligoglycosides can be derived from aldoses and/or ketoses having 5 or 6 carbon atoms, preferably glucose. The preferred alkyl and/or alkenyl oligoglycosides are thus alkyl and/or alkenyl oligoglucosides. The index number p in formula (I) gives the degree of oligomerization (DP), i.e. the distribution of mono-glycosides and oligoglycosides, and is an average number, usually fractional, between 1 and 10. Whereas p for a given compound must always be a whole number, and here in particular can assume the values p=1 to 6, the value p for a specific alkyl(oligo)glycoside product is an analytically determined calculated parameter which in most cases is a fractional number. Preference is given to using alkyl and/or alkenyl oligoglycosides with an average degree of oligomerization p of from 1.1 to 3.0. From an applications point of view, preference is given to those alkyl and/or alkenyl oligoglycosides whose degree of oligomerization is less than 1.7 and is in particular between 1.2 and 1.4. The alkyl and/or alkenyl radical R¹ can be derived from primary alcohols having 4 to 11, preferably 8 to 10, carbon atoms. Typical examples are butanol, caproic alcohol, caprylic alcohol, capric alcohol and undecyl alcohol, and technical-grade mixtures thereof as are obtained, for example, in the hydrogenation of technical-grade fatty acid methyl esters or in the course of the hydrogenation of aldehydes from the Roelen oxo synthesis. Preference is given to alkyl (oligo)glucosides of chain length C₈-C₁₀ (DP=1 to 3) which are produced as the forerun in the distillative separation of technical-grade C₈-C₁₈-coconut fatty alcohol, and can be contaminated with a fraction of less than 6% by weight of C₁-C₂-alcohol, and also alkyl oligoglucosides based on technical-grade C9/11-oxo alcohols (DP=1 to 3). In addition the alkyl and/or alkenyl radical R¹ can also be derived from primary alcohols having 12 to 22, preferably 12 to 14, carbon atoms. Typical examples are lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol, and technical-grade mixtures thereof which can be obtained as described above. Preference is given to alkyl(oligo)glucosides based on hydrogenated C12/14 coconut alcohol with a DP of from 1 to 3.

Such alkyl(oligo)glycosides are commercially available, for example, as APG®, GLUCOPON®, or PLANTAREN® surfactants from Cognis Corporation. Other examples include alkyl(oligo)glycoside surfactant compositions which are comprised of mixtures of compounds of formula (I) wherein G represents a moiety derived from a reducing saccharide containing 5 or 6 carbon atoms; p is a number having a value from 1 to about 6; and R¹ is an alkyl radical having from 8 to 20 carbon atoms. The compositions are characterized in that they have increased surfactant properties and an HLB in the range of about 10 to about 16 and a non-Flory distribution of glycosides, which is comprised of a mixture of an alkyl monoglycoside and a mixture of alkyl polyglycosides having varying degrees of polymerization of 2 and higher in progressively decreasing amounts, in which the amount by weight of polyglycoside having a degree of polymerization of 2, or mixtures thereof with the polyglycoside having a degree of polymerization of 3, predominate in relation to the amount of monoglycoside, said composition having an average degree of polymerization of about 1.8 to about 3. Such compositions, also known as peaked alkyl polyglycosides, can be prepared by separation of the monoglycoside from the original reaction mixture of alkyl monoglycoside and alkyl polyglycosides after removal of the alcohol.

Other alkyl(oligo)glycosides which can be used in the compositions according to the invention are those in which the alkyl moiety contains from 6 to 18 carbon atoms in which the average carbon chain length of the composition is from about 9 to about 14 comprising a mixture of two or more of at least binary components of alkyl(oligo)glycosides, wherein each binary component is present in the mixture in relation to its average carbon chain length in an amount effective to provide the surfactant composition with the average carbon chain length of about 9 to about 14 and wherein at least one, or both binary components, comprise a Flory distribution of polyglyco sides derived from an acid-catalyzed reaction of an alcohol containing 6-20 carbon atoms and a suitable saccharide from which excess alcohol has been separated.

The preferred alkyl(oligo)glycosides are those of formula (I) wherein R¹ is a monovalent organic radical having from about 8 to about 10 carbon atoms; G is a glucose residue having 5 or 6 carbon atoms; and p is a number having a value from 1 to about 3, most preferably about 1.6.

A second class of preferred nonionic surfactants is fatty alcohol alkoxylates, preferably the fatty alcohol ethoxylates. Such alcohol ethoxylates are known from their production as fatty alcohol ethoxylates or as oxoalcohol ethoxylates and preferably correspond to general formula R′O(CH₂CH₂O)ₙH in which R′ is a linear or branched alkyl and/or alkenyl group containing 6 to 22 carbon atoms and n is a number of 1 to 50, preferably 3 to 30 and more particularly 3 to 12. Typical examples are the adducts of, on average, 1 to 50, preferably 5 to 40 and more particularly 10 to 25 mol of ethylene oxide with, for example, caproic alcohol, caprylic alcohol, capric alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, arachyl alcohol, gadoleyl alcohol, behenyl alcohol, erucyl alcohol and bras sidyl alcohol and the technical mixtures thereof obtained, for example, in the high-pressure hydrogenation of technical methyl esters based on fats and oils, or aldehydes from Roelen's oxosynthesis, or the monomer fraction in the dimerization of unsaturated fatty alcohols (known in the art as dimer alcohols). Adducts of 5 to 40 mol of ethylene oxide with technical C12-C18 fatty alcohols, such as for example coconut oil, palm oil, palm kernel oil or tallow fatty alcohol, are also preferred.

A combination of other nonionic surfactants with the alkyl(oligo)glycoside, and or the fatty alcohol alkoxylates, or the use of different types of nonionic surfactants instead of alkyl(oligo)glycosides or fatty alcohol ethoxylates is also possible and of advantage in the sense of the present invention.

A preferred blend of nonionic surfactants comprises alkyl(oligo)glycosides and fatty alcohol alkoxylates. The fatty alcohol alkoxylates are described in detail in the paragraphs before. Such blends may also contain water in amounts from 0.1 to 20.0 wt %, but preferably between 1.0 and 6.0 wt %, based on the total weight of the blend. Based on the source of the blend components, other compounds, like fatty alcohols may be present as well. Preferred blends of this kind always contain a majority of the alkyl(oligo)glycoside, compared to the amount of fatty alcohol alkoxylate. Examples of such blends contain from 51.0 to 95.0 wt % of alkyl(oligo)glycosides, and from 5.0 to 49.0 wt % of fatty alkyl ethoxylates, from 0.1 to 10 wt % water, and from 0.0 to 10 wt % other ingredients.

As the water content of the compositions according to the invention is a critical feature for packaging in a water-soluble pouch, those nonionic surfactants are preferred which contain a low water content. For the purpose of the present invention, low water content means 20 wt % or less, preferably less than 10 wt % and most preferred less than 5 wt %. The lower amount of water could be zero, or being in the range of 2 to 0.5 wt %. Such alkyl(oligo)glycoside compounds are described, for example, in U.S. Pat. No. 6,235,703.

The second required ingredient for the compositions of the invention is at least one anionic surfactant. Preferred anionic surfactants are selected from the group consisting of alkyl sulfates, alkyl ether sulfates, sulfofatty acid esters, sulfofatty acid disalts, alkyl benzene sulfates, and combinations thereof.

A class of preferred anionic surfactants is the alkyl ether sulfates. Alkyl ether sulfates are generally defined as salts of sulfated adducts of ethylene oxide with fatty alcohols containing from about 8 to about 16 carbon atoms. The alkyl ether sulfates employed in the present invention are commercially available and contain a linear aliphatic group having from about 8 to about 16 carbon atoms, and preferably from about 12 to about 16 carbon atoms. The degree of ethoxylation is from 1 to about 10 moles of ethylene oxide, and preferably about 2 to 3 moles of ethylene oxide.

A particularly preferred alkyl ether sulfate for use in the present invention is C12-C16 ether sulfate having 2 moles of ethylene oxide, commercially available under the tradename TEXAPON® N-70. In a particularly preferred embodiment of the present invention, the alkyl ether sulfate concentrate is based on a C12-C16 ether sulfate ethoxylated with 2 moles of ethylene oxide.

Another class of preferred anionic surfactants is selected from the group of alkyl sulfate surfactants. Alkyl and/or alkenyl sulfates, frequently also referred to as fatty alcohol sulfates, are the sulfation products of primary and/or secondary alcohols, conforming preferably to formula (II)

R²O—SO₃Y (II)

in which R² is a linear or branched, aliphatic alkyl and/or alkenyl radical having from 6 to 22, preferably from 12 to 18 carbon atoms, and Y is an alkali metal and/or alkaline earth metal, ammonium, alkylammonium, alkanolammonium or glucammonium.

Typical examples of alkyl sulfates that may be used in the context of the invention are the sulfation products of caproyl alcohol, caprylyl alcohol, capryl alcohol, 2-ethylhexyl alcohol, lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, and erucyl alcohol, and their technical mixtures obtained by high-pressure hydrogenation of industrial methyl ester fractions or aldehydes from the Roelen oxo synthesis. The sulfation products may be used preferably in the form of their alkali metal salts, and in particular of their sodium salts. Particular preference is given to alkyl sulfates based on C16/18 tallow fatty alcohols or vegetable fatty alcohols of comparable carbon distribution, in the form of their sodium salts. In the case of branched primary alcohols, the compounds in question are oxo alcohols, obtained, for example, by reacting carbon monoxide and hydrogen with alpha-olefins by the Shop process.

Other types of known anionic surfactants could also be used in place of, or in combination with the alkyl ether sulfates. The anionic surfactants will be present in the cleaning compositions of the invention in preferred amounts of 10 to 35 wt %, and most preferably 15 to 25 wt %.

The third required component of the present compositions is a non-aqueous solvent (iii). Preferred examples thereof are selected from the group consisting of glycerol, propylene glycol, ethylene glycol, hexylene glycol, and carboxylic acid alkyl esters with more than 12 carbon atoms.

The non-aqueous solvent may be present in amounts from 0.1 to 50 wt %, preferably 1 to 25 wt %, based on the weight of the composition. A most preferred range is 5 to 15 wt %.

Finally, the cleaning compositions of the present invention always contain water in amounts of less than 10 wt % to the lower limit of zero wt %. The cleaning compositions are packaged in water-soluble containers to form the unit dose systems, and therefore the amount of water in the cleaning composition must be low, as otherwise the water-soluble container material may be dissolved prior to use.

As a totally water-free composition is difficult to obtain, it is preferred to adjust the water content in the range from less than 10 wt % to app. 5 wt %, more preferably between less than 10 wt % and 8 wt %. Most preferably, the amount of water (referring always to the total water amount in the composition) is set between 9.99 wt % and 8.10 wt %. A most especially preferred range is between 9.5 wt % as upper and 8.5 wt % as lower limit.

Besides the before mentioned ingredients, the detergent compositions of the present invention may also comprise further additives, for example inorganic bases, organic bases, inorganic acids, organic acids, antifoams, builders, viscosity regulators, biocides, preservatives, enzymes, enzyme stabilizers, dyes, perfumes, fragrances, emulsifiers, bleaches, bleach activators, hydroxycarboxylic acids, phosphonates, and combinations thereof. Such further additives may be present in amounts of 0.1 to 25 wt % in total.

The detergent compositions according to the present invention preferably comprise:

25.0 to 70.0 wt % of compound(s) (i);

10.0 to 20.0 wt % of compound(s) (ii);

5.0 to 15 wt % of compounds(s) (iii);

8.1 to 9.5 wt % of water, and

optionally, 1.0 to 20.0 wt % of further ingredients.

All amounts are calculated on the weight of the total composition. In an additional embodiment, the compound (i) is selected from alkyl(oligo)glycoside surfactants, compound (ii) is selected from alkyl ether sulfate surfactants, and compound (iii) is selected from 1,3-propanediol, 1,2-propanediol or glycerol. If further additives are present, these are selected from ethyl hexyl palmitate and/or mono ethanolamine and/or triethanolamine.

According to the selection of the ingredients it is possible to provide detergent compositions which consist only of substances based on natural or renewable raw materials, and will not make use of any petrochemical-based material, which render such compositions as preferred with regard to CO₂ emissions and carbon footprint.

The detergent compositions of the present invention are specifically designed to be used in pouches or sachets, or any other unit-dose system. Therefore, a further embodiment pertains to a detergent packet, comprising at least one compartment, surrounded by a water-soluble film, comprising polyvinyl alcohol, and including the detergent composition as described before.

The container preferably is a pouch or sachet, which comprises a water-soluble film, which totally surrounds the cleaning composition. In general, the pouch can be made from any material suitable for use in conventional unit-dose laundry products. However, it has been found that certain polymer and/or copolymers and/or derivatives thereof are preferred. Preferred polymer and/or copolymers and/or derivatives thereof are selected from polyvinyl alcohol (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum; and mixtures thereof. More preferably the polymer is selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and mixtures thereof, most preferably polyvinyl alcohols, polyvinyl alcohol copolymers, hydroxypropyl methyl cellulose (HPMC), and mixtures thereof.

PVA is the preferred water-soluble material to provide the container. PVA is generally partially or fully alcoholyzed or hydrolyzed (e.g., 40-100 percent, preferably 80-99 percent alcoholyzed or hydrolyzed) and comes in many different varieties including biodegradable and edible films, cold and hot water-soluble films, and a number of different formulations to ensure compatibility with various products.

The present invention will be illustrated, without limitation, by the following examples.

### EXAMPLES

Certain formulations were prepared for introduction into PVA cleaning packets. The formulations 1-2 are given in detail in the following tables. Formulations 2a and 2b comprise ingredients which are not petrochemical based.

### Example 1a

| Ingredient | % wt | active % wt | water % wt |
|---|---|---|---|
| Nonionic surfactant blend¹⁾ | 49.0 | 46.0 | 3.0 |
| Fatty acid | 3.0 | | |
| 1,3-propanediol | 8.0 | | |
| TEXAPON ® N70²⁾ | 19.0 | 13.3 | 5.7 |
| Glycerine | 14.0 | | |
| Monoethanolamine | 4.0 | | |
| CETIOL ® EHP³⁾ | 3.0 | | |
| totals | 100.0 | 59.3 | 8.7 |

¹⁾Blend of 53 wt % active alkyl(oligo)glycoside (GLUCOPON ® 600 UP) and 42 wt % fatty alcohol ethoxylate (DEHYDOL ® LT-7) with 5 wt % water.
²⁾Alkylethersulfate
³⁾Ethylhexyl palmitate to promote clarity

### Example 1b

| Ingredient | % wt | active % wt | water % wt |
|---|---|---|---|
| Alkyl(oligo)glycoside | 53.0 | 50.0 | 3.0 |
| Fatty acid | 3.0 | | |
| 1,3-propanediol | 8.0 | | |
| TEXAPON ® N70²⁾ | 15.0 | 11.0 | 4.0 |
| Glycerine | 14.0 | | |
| Monoethanolamine | 4.0 | | |
| CETIOL ® EHP³⁾ | 3.0 | | |
| totals | 100.0 | 61.0 | 7.0 |

### Example 2a

| Ingredient | % wt | active % wt | water % wt |
|---|---|---|---|
| Nonionic surfactant blend ¹⁾ | 63.0 | 18.9 | |
| TEXAPON ® ALS -70 ⁴⁾ | 27.0 | 18.9 | 8.1 |
| 1,3-propanediol | 10.0 | | |
| totals | 100.0 | 57.8 | 8.1 |

⁴⁾ Alkylbenzenesulfate

### Example 2b

| Ingredient | % wt | active % wt | water % wt |
|---|---|---|---|
| Nonionic surfactant blend ¹ | 65.0 | 32.5 | 3.0 |
| TEXAPON ® ALS -70 ⁴⁾ | 25.0 | 17.5 | 7.5 |
| 1,3-propanediol | 10.0 | | |
| totals | 100.0 | 50.0 | 10.5 |

### Performance Tests

Formulations 1a and 2a where tested for their detergency properties. Test swatches (Cotton 400) were soiled with standard soil (Dust Sebum, clay, carbon black) and washed under the following conditions: Temperature 90° F.; washing time 10 minutes; cold rinse; spin drying at 150 rpm. Two swatches of each soil and 1 unsoiled swatch, 2 runs per product. The test dosage was determined by the volume of 1 pouch (15 ml) in a typical US top-loader on medium load (60 liters): 15 ml/60 1=0.25 ml/l. After drying, the swatches where examined as to their reflectance with a Konica Minolta CR-410 Colorimeter. All test swatches were measured front & back and the results averaged. Soil Removal (SR) results are the average of four swatches per product and are expressed in terms of E (see Table 1).

The SR results are reported in the following table:

| Formulation | 1b | 2b |
|---|---|---|
| Total Soil Removal | 94.3 | 67.8 |
| Totals Soils (no redeposition) | 99.9 | 74.3 |

TABLE 1
Soil and Stain Removal Scores Defined
$\% SR ( E ) = \frac{Ei - Ef}{Ei} \times 100$
Swatches measured before washing:
Ei = ((Lu − Lo)² + (au − ao)² + (bu − bo)²)^{1/2}
Swatches measured after washing:
Ef = ((Lw − Lo)² + (aw − ao)² + (bw − bo)²)^{1/2}
u = unwashed stained swatch
w = washed stained swatch
o = unwashed, unstained swatch

What is claimed is:

1. A liquid detergent composition comprising:
(i) at least one nonionic surfactant,
(ii) at least one anionic surfactant,
(iii) at least one non-aqueous solvent, and
(iv) water,
wherein the water content of the composition is less than 10% by weight, and the composition is free of volatile organic compounds.

2. The liquid detergent composition of claim 1, wherein the water content is between 8.0 wt % and less than 10 wt %, based on the weight of the composition.

3. The liquid detergent composition of claim 1, wherein said nonionic surfactant (i) is selected from the group consisting of alkyl(oligo)glycosides, linear alcohol ethoxylates and mixtures thereof.

4. The liquid detergent composition of claim 1, wherein said anionic surfactant (ii) is selected from alkyl ether sulfates.

5. The liquid detergent composition of claim 1, wherein said non-aqueous solvent is selected from the group consisting of 1,3-propanediol, 1,2-propanediol and glycerol.

6. The liquid detergent composition of claim 1, wherein said nonionic surfactant (i) is present in amounts from 30 to 90 wt % based on the composition.

7. The liquid detergent composition of claim 1, wherein said nonionic surfactant (i) is present in amounts from 40 to 70 wt % % based on the composition.

8. The liquid detergent composition of claim 1, wherein said anionic surfactant (ii) is present in amounts from 10 to 35 wt % % based on the composition.

9. The liquid detergent composition of claim 1, wherein said anionic surfactant (ii) is present in amounts from 15 to 25 wt % % based on the composition.

10. The liquid detergent composition of claim 1, wherein said non-aqueous solvent (iii) is present in amounts from 1 to 25 wt % % based on the composition.

11. The liquid detergent composition of claim 1, wherein said non-aqueous solvent (iii) is present in amounts from 1 to 15 wt % % based on the composition.

12. The liquid detergent composition of claim 1, which is free of quaternized ammonium compounds.

13. The liquid detergent composition of claim 1, which is free of fabric softening clays, fabric softening silicones and mixtures thereof.

14. The liquid detergent composition of claim 1, which has a pH in the range from 7 to 11.

15. The liquid detergent composition of claim 1, which has a pH in the range from 8 to 10.

16. The liquid detergent composition of claim 1, further comprising glycerine and/or monoethanolamine.

17. The detergent composition of claim 1, wherein said liquid detergent composition is packaged in a container comprising a water-soluble material.

18. The detergent composition of claim 1, wherein said liquid detergent composition is packaged in a container comprising polyvinyl alcohol.

19. A detergent packet, comprising at least one compartment, surrounded by a water-soluble film comprising polyvinyl alcohol, and containing the detergent composition of claim 1.
